(19) United States
(12) Patent Application Publication
(10) Pub. No.: US 2010/0083911 A1
(43) Pub. Date: Apr. 8, 2010

(54) RIDER SIMULATION APPARATUS, SYSTEM AND METHOD

(76) Inventor: LARRY GARDNER, New Waverly, TX (US)

Correspondence Address: Scott David Compton (The Compton Law Firm, P.C.), 2386 S. Dairy Ashford St. #593, Houston, TX, 77077, US

(21) Appl. No.: 12/572,639

(22) Filed: Oct. 2, 2009

Related U.S. Application Data
(60) Provisional application No. 61/195,017, filed on Oct. 2, 2008.

(51) Int. Cl. A01K 15/02; A01K 29/00

(52) U.S. Cl. 119/720; 119/712; 119/856

(57) ABSTRACT

The present application is directed to developing animals using a non-human rider simulation apparatus. The rider simulation apparatus includes a torso, a securing means for releasably mounting the apparatus to an animal, and a resilient means for connecting the torso to the securing means.

### CROSS-REFERENCE TO RELATED APPLICATIONS

The present application claims the benefit of U.S. Provisional Patent Application Ser. No. 61/195,017, filed Oct. 2, 2008.

### STATEMENT REGARDING FEDERALLY SPONSORED RESEARCH OR DEVELOPMENT

Not Applicable.

### REFERENCE TO A MICROFICHE APPENDIX

Not Applicable.

### FIELD OF THE APPLICATION

The present application is related to developing animals by simulating human riders.

### BACKGROUND

Various animals are ridden by mankind for recreation, sport, labor and necessity. In fact, many animals are specially bred for various activities that involve carrying human riders. For example, rough stock animals are often bred for rodeo use. Thus, starting at a young age rough stock animals are evaluated for strength, agility, bucking ability, and the propensity to buck in the attempt to dislodge a rider from its backside. Often times, it is desirable to make such evaluations without actually using a live human rider. Simulating the physiological movement and action of a human rider is needed.

### SUMMARY

The present application is directed to a rider simulation apparatus comprising a torso, a securing means for releasably mounting the apparatus to an animal, and a resilient means for connecting the torso to the securing means in a neutral first position.

The present application is also directed to a rider simulation apparatus releasably mountable to a rough stock animal comprising a substantially human-like skeletal framework including a torso, lower extremities, and a resilient means for connecting the lower extremities to the torso, the resilient means being operationally configured to center the torso during operation of the apparatus.

The present application is also directed to a method for developing a rough stock animal, comprising (1) providing a rider simulation apparatus comprising a torso, a securing means for releasably mounting the apparatus to an animal, and a resilient means for connecting the torso to the securing means, (2) releasably mounting the rider simulation apparatus to a subject animal, (3) observing the animal for a predetermined period of time, (4) and activating the release of the apparatus from the animal following said period of time.

The present application is also directed to a system for developing a rough stock animal, comprising (1) a bucking dummy releasably securable to a subject animal, (2) a remote control in wireless communication with the bucking dummy, and (3) a rider simulation apparatus comprising a torso, a securing means for releasably mounting the apparatus to an animal, and a resilient means for connecting the torso to the securing means, the rider simulation apparatus being releasably securable to the bucking dummy.

### DESCRIPTION OF THE FIGURES

FIG. 1 is a front perspective view of a rider simulation apparatus.

FIG. 2 is a front perspective view of another rider simulation apparatus.

FIG. 3 is a perspective view of an embodiment of a resilient means of the rider simulation apparatus shown in a neutral position.

FIG. 4 is a perspective view of an embodiment of a resilient means in a non-neutral position.

FIG. 5 is a perspective view of another embodiment of a resilient means in a neutral position including a phantom view illustrating a non-neutral position of the resilient means.

FIG. 6 is a perspective view of another embodiment of a resilient means in a non-neutral position including a phantom view of the resilient means in a neutral position.

FIG. 7 is a perspective view of an embodiment of a shoulder type attachment.

FIG. 8 is a front perspective view of a torso including upper extremities, and a resilient means illustrating exemplary directional movement of an upper extremity during operation of the rider simulation apparatus.

FIG. 9 is a perspective cross sectional view of an embodiment of the rider simulation apparatus including an endoskeleton, an outer protective layer, and clothing covering the outer protective layer.

FIG. 10 is a perspective cross sectional view of another embodiment of the rider simulation apparatus including an endoskeleton, an outer protective layer, and clothing covering the outer protective layer.

FIG. 11 is an exemplary embodiment of a rider simulation apparatus used in conjunction with a known bucking dummy.

FIG. 12 is an exemplary embodiment of a rider simulation apparatus during operation.

### BRIEF DESCRIPTION

The present disclosure of the invention will be expressed in terms of its various components, elements, constructions, configurations, arrangements and other features that may also be individually or collectively referenced by the term, “aspect(s)” of the invention, or other similar terms. It is contemplated that the various forms of the disclosed invention may incorporate one or more of its various features and aspects, and that such features and aspects may be employed in any desired, operative combination thereof. Various exemplary embodiments of the invention are provided to illustrate more broadly applicable aspects of the present invention in a non-limiting sense. Various changes may be made to the invention described and equivalents may be substituted without departing from the true spirit and scope of the invention. In addition, many modifications may be made to adapt a particular situation, material, composition of matter, process, process act(s) or step(s) to the objective(s), spirit or scope of the present invention. All such modifications are intended to be within the scope of the claims made herein.

It has been discovered that an apparatus can be provided to simulate a human being riding an animal, including a bucking animal. In particular, the present rider simulation apparatus is operationally configured to simulate one or more of the following body characteristics during operation upon an animal: human arm motion, human leg motion, human head motion, human torso motion, and human core or midsection motion. Heretofore, such a desirable achievement has not been considered possible, and accordingly, the apparatus described herein measures up to the dignity of patentability and therefore represents a patentable concept.

Before describing the invention in detail, it is to be understood that the present rider simulation apparatus, system and method are not limited to particular embodiments. It is also to be understood that the terminology used herein is for the purpose of describing particular embodiments only, and is not intended to be limiting. As used in this specification and the appended claims, the term “resilient” refers to being capable of returning to an original shape and/or position and/or orientation. The term “endoskeleton” refers to a relatively hard and/or rigid and/or stiff skeletal type framework, configured to be wholly or partially covered by one or more materials. The terms “animal” and “riding animal” refer to any animal capable of being ridden by a human. The phrase “bucking dummy” refers to commercially available weighted electronic bucking dummies that are placed on the back of an animal during operation. The phrase “neutral position” refers to a starting position of the rider simulation apparatus or an individual human rider when mounted to an animal. The term “develop” and like terms refers to one or more of the following: the testing, exercising, training, improving, breaking, evaluating, strengthening, and judging of animals in relation to carrying human riders. The phrase “human rider movement” and like terms refers to either or both the intentional movement of a person while riding an animal and the reactionary movement of a person while riding an animal. The term “core” refers to the human muscular anatomy that controls and supports the spine and pelvis. Muscles of the abdominal region that control and support the spine and pelvis include, for example, (1) internal and external obliques which rotate the torso from side to side and bends the torso to the side; (2) the rectus abdominus, which flexes the torso; and (3) the transverse abdominus, which stabilizes the spine to prevent excessive motion in any direction. Muscles of the back region that control and support the spine and pelvis include, for example, (1) the erector spinae that run along each side of the spine and extends the torso; and (2) the quadratus lumborum, which, like the obliques, bends the torso to the side and controls the hiking motion of the hip.

In one aspect, the present application provides an apparatus, system and method for developing animals, thereby eliminating the need for using an actual human rider.

In another aspect, the present application provides an apparatus comprised of durable and resilient construction.

In another aspect, the present application provides an apparatus, system and method for developing animals while reducing the risk of injury to a subject animal.

In another aspect, the present application provides an apparatus that may be used by young and/or immature animals by adapting the size and weight of the apparatus as desired.

In another aspect, the present application provides an apparatus, system and method for achieving a desired response from a subject animal by releasing the apparatus or the apparatus/bucking dummy combination after the animal has performed a desired bucking action for a predetermined period of time.

In another aspect, the present application provides a human like apparatus comprising a midsection region operationally configured to simulate the action of a human midsection region.

In another aspect, the present application provides a rider simulation apparatus operationally configured to provide a human like response when mounted to an animal such as rough stock animals, including counteracting the movement of the animal.

In another aspect, the present application provides a human like apparatus comprising a core region configured to simulate the action of a human core region including the ability to direct the torso from a neutral position to a bent or flexed position and then redirect the torso to the neutral position prior to directing the upper torso to a second bent or flexed position.

In another aspect, the present application provides a human like apparatus comprising a core region configured to simulate the action of a human core region in a manner effective to reduce or otherwise eliminate any whipping motion of the torso during operation.

In another aspect, the present application provides an apparatus, system and method for achieving a desired response from a subject animal by adding a human scent to the apparatus that is either familiar or unfamiliar to the animal.

In another aspect, the present application provides a human like apparatus comprising a free upper extremity configured to simulate a rodeo cowboy's free hand/arm including the simulation of the movement of the free arm in like manner as a rodeo cowboy's free arm while riding rough stock animals.

In another aspect, the present application provides a human like apparatus comprising an upper extremity configured to simulate a rodeo cowboy's riding hand/arm that is typically located in front of the rider and possibly grasping a rope or similar object in like manner as a rodeo cowboy.

In another aspect, the present application provides a human like apparatus comprising lower extremities operationally configured to simulate human legs including applying pressure to either side of the subject animal.

In another aspect, the present application provides a human like apparatus comprising lower extremities configured to simulate the spurring action of a human rider's legs to the sides of a subject animal.

In another aspect, the present application provides a method of equalizing or otherwise providing uniformity to the scoring system used in rodeo events by eliminating the variables associated with using human riders of different experience/skill levels by replacing human riders with the present apparatus.

In another aspect, the present application provides an apparatus, system and method effective to induce a maximum bucking action from the subject animal bearing the apparatus.

In another aspect, the present application provides an apparatus operationally configured to react to the movements of the animal bearing the apparatus, including counteracting the animal's bucking type movement.

In another aspect, the present application provides an apparatus, system and method effective for eliminating or otherwise reducing injuries suffered by human riders by first developing a rough stock animal with the apparatus rather than having a human rider attempt to ride a novice animal—not knowing the novice animal's tendencies in response to having a human rider on its back.

In another aspect, the present application provides an apparatus comprising an endoskeleton enveloped by an outer protective layer having a substantially human-like anatomically-correct, surface geometry.

In another aspect, the present application provides an apparatus operationally configured for the releasable attachment of the apparatus to a subject animal including release of the apparatus at a predetermined time following attachment to the animal.

In another aspect, the present application provides an apparatus including an upper portion, a midsection, and a lower portion that has a saddle type base and lower extremities, the saddle type base being releasably attachable to the subject animal.

In another aspect, the present application provides an apparatus comprising circuitry operationally configured to electronically release the apparatus from a subject animal.

In another aspect, the present application provides an apparatus comprising circuitry operationally configured to electronically release the apparatus from a subject animal via a remote control means.

In another aspect, the present application provides an apparatus comprising circuitry including a safety means operationally configured to release the apparatus from a subject animal at a desirable time during use of the apparatus.

The rider simulation apparatus, system and method according to the present application will be described in more detail with reference to the embodiments illustrated in the drawings. The drawings are illustrative only, and are not to be construed as limiting the invention.

### DETAILED DESCRIPTION

The present application provides a rider simulation apparatus embodying a substantially human-like form. In one simplified embodiment, the rider simulation apparatus comprises a skeletal-type framework including at least a torso, a securing means for releasably mounting the apparatus to an animal, and a resilient means interconnecting the torso and the securing means. In another simplified embodiment, the rider simulation apparatus comprises a skeletal framework enveloped by an outer protective layer, the outer protective layer having substantially human-like anatomically-correct, surface geometry.

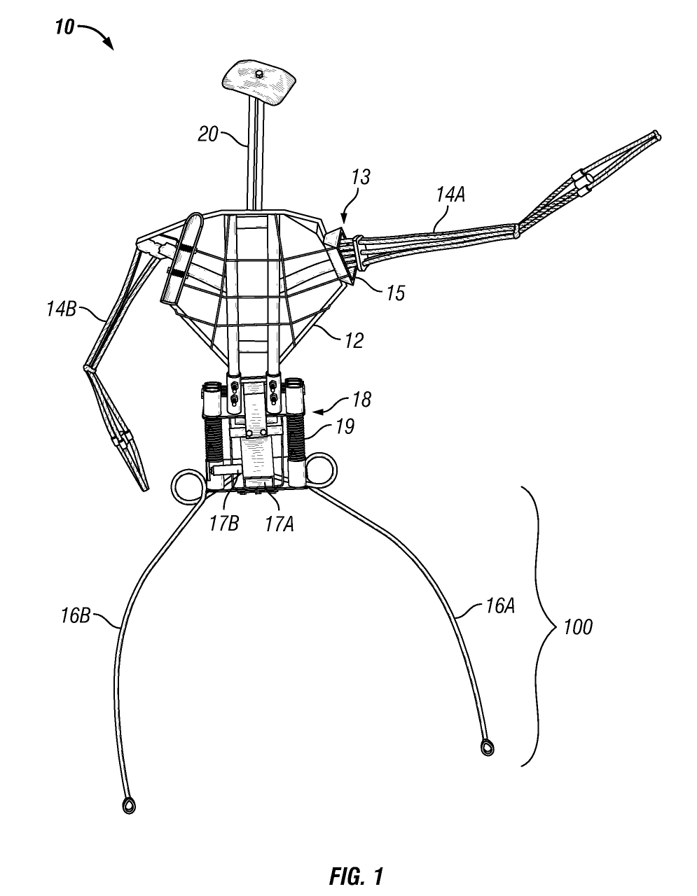

Referring first to FIG. 1, there is indicated generally by numeral 10 an embodiment of a rider simulation apparatus 10 comprising an assembled framework including at least (1) a torso 12, (2) a securing means 100 defined by lower extremities 16A, 16B, and (3) a resilient means 18 interconnecting the torso 12 and the securing means 100. As desired, the rider simulation apparatus 10 may further include one or more upper extremities 14A, 14B attached to the torso 12, the one or more upper extremities 14A, 14B being operationally configured to simulate human arms. In like manner, the lower extremities 16A, 16B are operationally configured to simulate human legs. As desired, one or more extremities may be excluded from the rider simulation apparatus 10 altogether.

With continued reference to FIG. 1, the rider simulation apparatus 10 may also include a neck member 20 extending from the torso 12. In addition, the rider simulation apparatus 10 may include a mating member 17A for releasably securing the rider simulation apparatus 10 to (1) a subject animal, or (2) to another object releasably or permanently secured to a subject animal including, for example, a known bucking dummy 40.

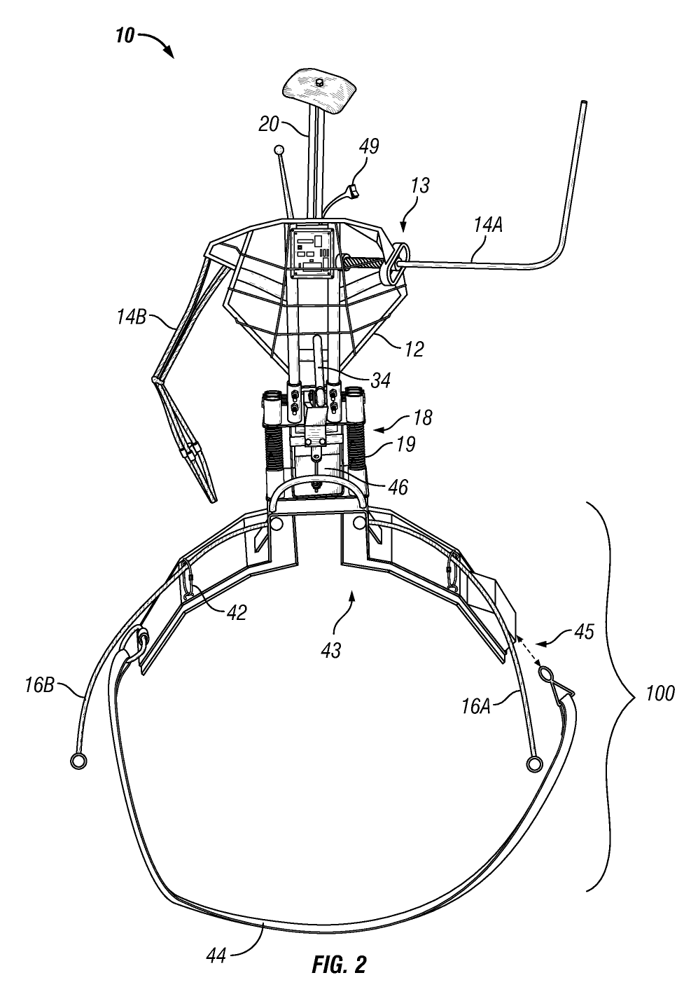

FIG. 2 depicts another embodiment of the rider simulation apparatus 10 including at least (1) a torso 12, (2) a resilient means 18, and (3) a securing means 100 including a girdle type configuration effective to releasably secure the rider simulation apparatus 10 to a subject animal. Suitably, the securing means 100 comprises a base 43, and one or more straps 44 including a latching means 45 for releasably securing the rider simulation apparatus 10 to a subject animal.

The rider simulation apparatus 10 may further include a power supply 46 and circuitry operationally configured for either manual or automatic release of the latching means 45 during operation. Generally, the circuitry is operationally configured to signal the unlocking of the latching means 45 as desired. In one implementation, a remote control means (not shown) may be used to signal the unlocking of the latching means 45. In another implementation, a timer switch 49 may be used to signal the unlocking of the latching means 45 at a predetermined time following activation. In yet another implementation, the timer switch 49 may be utilized as a backup or safety mechanism for unlocking the latching means 45 at a predetermined time following activation in the event that the remote control means malfunctions. Although not limited to a particular embodiment, suitable latching means 45 include, but are not necessarily limited to automobile trunk latching mechanisms, automobile seat belt locking mechanisms, and similar devices.

In one embodiment, the torso 12 may include a frame structure as depicted in FIGS. 1 and 2. In another embodiment, the torso 12 may include a hollow shell type configuration. Although not limited to particular materials of construction, the apparatus 10 framework, i.e., the torso 12, resilient means 18, and securing means 100, is constructed from one or more materials effective to maintain the basic form or shape of the rider simulation apparatus 10, i.e., a human-like shape, during operation. Ultimately, the apparatus 10 framework materials utilized may depend on the intended use of the rider simulation apparatus 10. For instance, rodeo bulls may weigh as much as two-thousand pounds, thus, the framework must be constructed from durable materials effective for withstanding tremendous forces. Suitable apparatus 10 materials include, but are not necessarily limited to metals, woods, plastic materials, composite materials, rubbers, and combinations thereof. Suitable composite materials include, but are not necessarily limited to fiberglass, carbon fiber reinforced plastic, and para-aramid synthetic fiber containing materials. A suitable plastic includes, but is not necessarily limited to polyvinyl chloride (“PVC”). Suitable wood include dense woods, for example hickory, oak, and maple. In one advantageous embodiment, the apparatus 10 framework is constructed from one or more metals. In a particularly advantageous embodiment, at least the torso 12 is constructed from stainless steel. In another particularly advantageous embodiment, at least the torso 12 is constructed from aluminum.

As explained further below, the rider simulation apparatus 10 is operationally configured to simulate the physical movement of a human riding an animal. As such, the rider simulation apparatus 10 provides various novel features effective for simulating human movement during a particular ride. For example, the first upper extremity 14A is suitably operationally configured to move about the torso 12 in a manner effective to simulate a human arm during a ride. In one embodiment, the first upper extremity 14A may move in a manner similar to the free arm of a person riding a rough stock animal. In addition, the resilient means 18 is suitably operationally configured to move, i.e., bend, compress, extend or otherwise flex in a similar manner as the core, midsection or waist region of a person riding a rough stock animal. The lower extremities 16A and 16B may also be operationally configured to apply pressure to the sides of the animal in a similar manner as a person riding rough stock. In still another embodiment, the lower extremities 16A and 16B may be operationally configured to spur an animal in like manner as a human rider.

Here forward, the application will be discussed in terms of using the rider simulation apparatus 10 with rough stock animals. Similar to other athletic activities, rough stock riding demands a strong core. Generally, a person's core plays an important role in stabilizing the spine, pelvis and shoulder girdle. In addition, the core plays an important role in the transfer of power through the body—from the lower extremities to the upper extremities. As a result, rough stock riders exude some basic characteristics with regard to physical movement—stemming largely from the action of the core in stabilizing the body during a particular ride. With this in mind, the resilient means 18 of this application is suitably operationally configured to move, i.e., bend, compress, extend or otherwise flex in a manner effective for the rider simulation apparatus 10 as a whole to simulate basic core characteristics during a ride. To further explain the novel features of the rider simulation apparatus 10, a description of typical human rider movement as related to various rough stock animals follows below.

(1) Saddle Bronc Riding

In saddle bronc riding, a rider begins with his/her his feet over the horse's shoulders. A rider optimally synchronizes his/her spurring action of the legs with the animal's bucking efforts. Model spurring action begins with the rider's feet forward on the horse's point of shoulder, sweeping to the back of the saddle, or “cantle,” as the horse bucks. The rider then snaps his/her feet back to the horse's neck before the horse's front feet hit the ground. All this is performed while the rider's free hand optimally does not touch the horse, himself/herself or the riding equipment. The present rider simulation apparatus 10 may be operationally configured to simulate the above described human movement related to saddle bronc riding.

(2) Bareback Riding

In bareback riding, an individual begins with his/her feet placed above the break of the horse's shoulders. Optimum spurring action begins with the rider's heels at the horse's neck. The rider then pulls his/her feet, toes turned outward, to the horse's withers until the rider's feet are nearly touching the bareback rigging. All this is performed while the rider's free hand optimally does not touch his/his equipment, himself/herself or the horse. The present rider simulation apparatus 10 may be operationally configured to simulate the above described human movement related to bareback riding.

(3) Bull Riding

Unlike the other rough stock contestants, bull riders are not necessarily required to spur. In bull riding, a rider attempts to remain forward or over the riding hand at all times, i.e., the midsection being in a tense or crunched position. Leaning back may cause the rider to be whipped forward when the bull bucks. A common bull ride is optimally performed without the rider's free hand touching his/his equipment, himself/herself or the bull.

The ability of a bull rider to keep his/her torso in a forward position relevant to the resilient means 18 (hereafter referred to as being “over the riding hand” as known to those of ordinary skill in bull riding) during a ride is accomplished largely by employing the core muscles. When the core muscles contract, they work to stabilize the spine, pelvis and shoulder girdle and create a solid base of support for a rider, allowing the rider to generate powerful movements of the extremities. Thus, a novel feature of the present rider simulation apparatus 10 includes the use of a resilient means 18 that is operationally configured in a manner effective to simulate the humanlike core action of a person during a ride. In simplest terms, the resilient means 18 is operationally configured to direct the torso 12 from a non-neutral second position to the neutral first position. In an embodiment of the rider simulation apparatus 10 intended for use with rodeo bucking bulls, the resilient means 18 is operationally configured to establish a resting neutral position of the torso 12 over the riding hand at the start of a particular ride.

As determined by the above described rough stock rider movement, a suitable resilient means 18 is operationally configured to move, i.e., bend, compress, extend or otherwise flex in a manner effective to allow the attached torso 12 to move from a neutral first position to a non-neutral second position around an indefinite number of axes having one common center in relation to the resilient means 18—in a similar manner as the core region of a human rider, including simulating the rolling of a rider's core, e.g., rolling the torso 12 from a forward bent position over to a sideways bent position. More suitably, the resilient means 18 is operationally configured to move, i.e., bend, compress, extend or otherwise flex in a manner effective to allow the attached torso 12 to move from a neutral first position to one or more non-neutral positions around an indefinite number of axes having one common center in relation to the resilient means 18 while eliminating any whipping motion of the torso 12 during operation of the rider simulation apparatus 10. In a particularly advantageous embodiment, the resilient means 18 is operationally configured to move, i.e., bend, compress, extend or otherwise flex in a manner effective to direct the attached torso 12 from a neutral first position to one or more non-neutral positions around an indefinite number of axes having one common center in relation to the resilient means 18 while controlling the movement or pace of the torso 12 during operation. In other words, the resilient means 18 allows the torso 12 to move to one or more non-neutral positions (including rolling from a first non-neutral position to a second non-neutral position) around an indefinite number of axes having one common center in relation to the resilient means 18, eventually redirecting the torso 12 to the neutral first position (hereafter referred to as “centering the torso 12” and like terms) where after the torso 12 may move to another non-neutral position as determined by the action of the subject animal. From each successive non-neutral position, the resilient means 18 is operationally configured to center the torso 12.

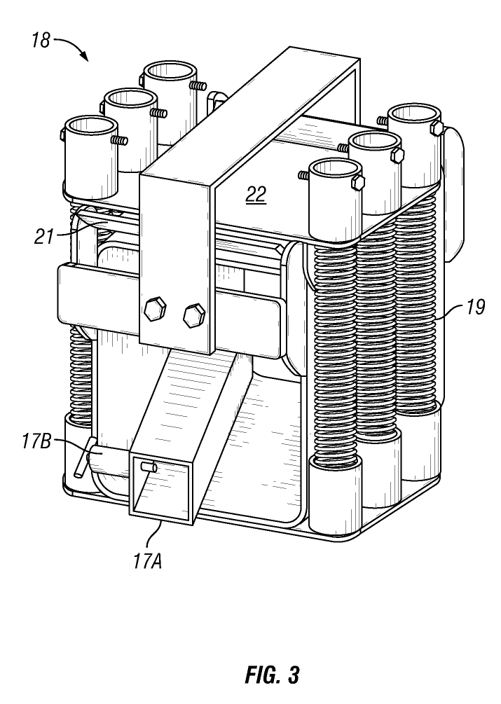

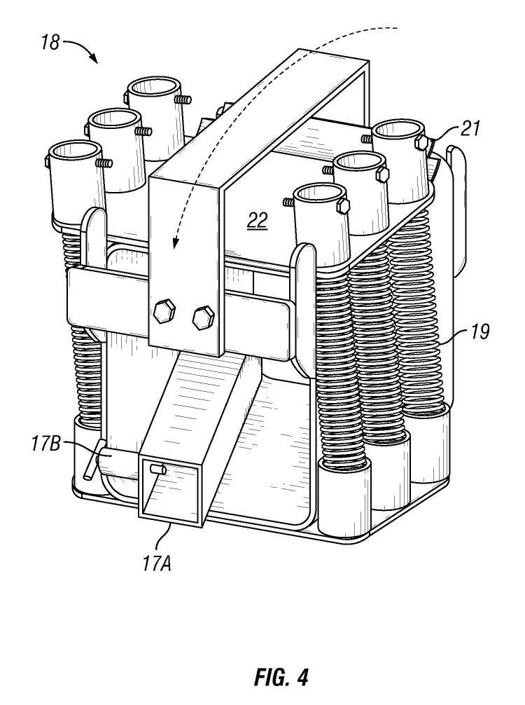

FIG. 3 depicts one exemplary embodiment of a suitable resilient means 18. In this embodiment, the resilient means 18 suitably includes a mating member 17A, including a locking pin 17B, for releasably securing the resilient means 18 to a known bucking dummy 40, a concave type plate 21 abutting a rocking member 22, the rocking member 22 being operationally configured to move from a neutral first position to one or more non-neutral positions around an indefinite number of axes having one common center in relation to the concave type plate 21, i.e., in a see-saw type fashion about 360 degrees. The orientation of the concave type plate 21 in relation to the rocking member 22 is maintained via one or more resilient members 19 as shown. During operation, as the torso 12 and the rocking member 22 move to a non-neutral position, the coil springs 19 located proximate the direction of torso 12 movement shorten or compress while the opposing coil springs 19 lengthen—as shown in the simplified illustration of FIG. 4. Following maximum directional movement of the torso 12, the resilient means 18 is configured to realign itself to the neutral first position. In this embodiment, suitable resilient members 19 include, but are not necessarily limited to elastomeric materials such as rubbers (natural and synthetic), one or more spring elements, such as coil springs and the like, and combinations thereof. As shown in FIG. 2, the resilient means 18 may further comprise a dampener 34 operationally configured to smooth out or damp shock impulse, and dissipate kinetic energy during operation of the rider simulation apparatus 10. Suitable dampeners include, but are not necessarily limited to pneumatic shock absorbers.

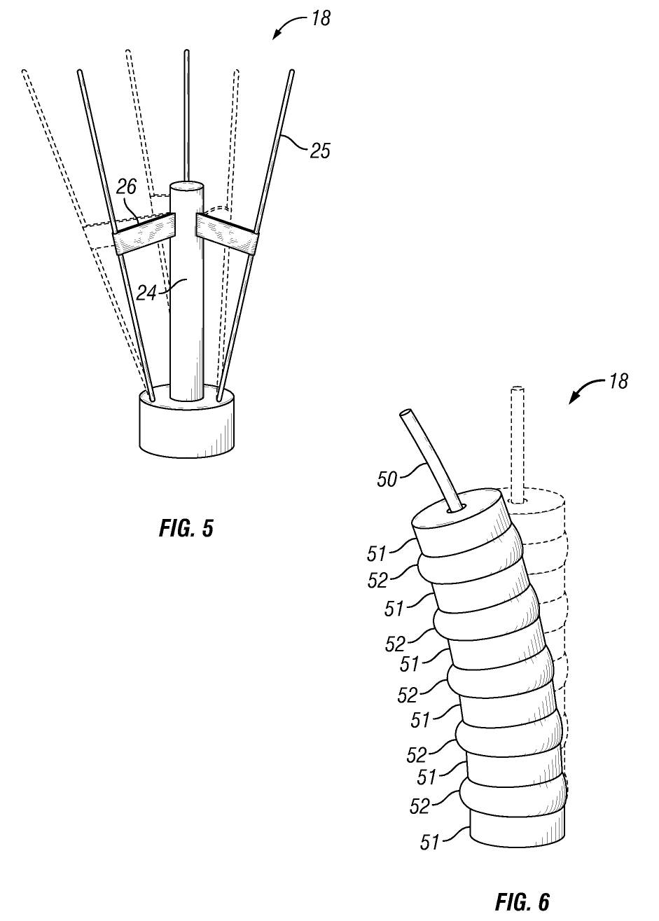

In another embodiment, the resilient means 18 may include a tension cord connected to both the upper extremities 14A, 14B and the lower extremities 16A, 16B that is resiliently bendable along 360 degrees. In still another embodiment, the resilient means 18 may include an inverted conical type configuration having a substantially rigid center member 24 and a plurality of substantially rigid outer members 25, each outer member 25 being connected to the center member 24 via one or more resilient connectors 26—as shown in FIG. 5. In the embodiment of FIG. 6, the resilient means 18 may include a vertebrae type configuration including a resilient center member 50, a plurality of solid members 51 interspaced by resilient members 52. In this embodiment, as the torso 12 is directed to a non-neutral position the center member 50 bends and one or more resilient members 52 are compressed as shown. As the torso 12 is directed back to a neutral position, the center member 50 returns to a substantially straight position and the one or more compressed resilient members 52 return to their original uncompressed form. Depending on the embodiment used, a suitable resilient means 18 is attached to the torso 12 by means including, but not necessarily limited to welds, adhesive means, ties, via the use of threaded fasteners including screws, tape, tongue and groove type configurations, and combinations thereof.

Suitably, the upper extremities 14A, 14B are operationally configured to work in conjunction with the resilient means 18 to simulate the characteristic arm movement of a rider—including the reactionary type arm movement of a rider in response to an animal's own movement or actions during a particular ride. Thus, the upper extremities 14A, 14B are suitably joined to the torso 12 in a manner effective to produce a desired simulated arm action. In other words, both the means of attachment of the upper extremities 14A, 14B to the torso 12 and the materials of construction of the upper extremities 14A, 14B may vary to best simulate a particular rider's characteristic arm movement atop a particular animal, rough stock or other. Furthermore, the upper extremities 14A, 14B may also include elbow-type joints or equivalent bends and/or wrist-like joints or equivalent bends as desired. The distal ends of the upper extremities 14A, 14B may also be operationally configured to attach to a separate saddle, a bucking dummy 40, rope, or to the rider simulation apparatus 10 during operation. Further still, upper extremity 14B may be operationally configured to rest in front of the resilient means 18 in similar fashion as the rope hand of a bull rider during a ride.

In a particularly advantageous embodiment, the first upper extremity 14A may be joined to the torso 12 at a shoulder type attachment 13 in a manner effective to produce one or more human like shoulder type articulations, including, but not necessarily limited to flexion (moving the upper extremity 14A upward toward the front of the torso 12); extension (moving the upper extremity 14A down toward the rear of the torso 12); adduction (moving the upper extremity 14A down toward the side of the torso 12); abduction (moving the upper extremity 14A away from the midline of the torso 12); transverse adduction (moving the upper extremity 14A toward and across the torso 12 with the back of the upper extremity 14A facing down); transverse flexion (moving the upper extremity 14A toward the midline of the torso 12 in a horizontal plane with the elbow facing out to the side of the torso 12); transverse abduction (moving the upper extremity 14A away from the midline of the torso 12 in a horizontal plane with the elbow facing down); transverse extension (moving the upper extremity 14A away from the midline of the torso 12 in a horizontal plane with the elbows out to the sides of the torso 12), and combinations thereof. In an embodiment of the rider simulation apparatus 10 configured to be used with rough stock animals, suitable shoulder type articulations of the first upper extremity 14A include, but are not necessarily limited to movement substantially similar to human abduction, transverse flexion, transverse abduction and transverse adduction as illustrated in FIG. 8.

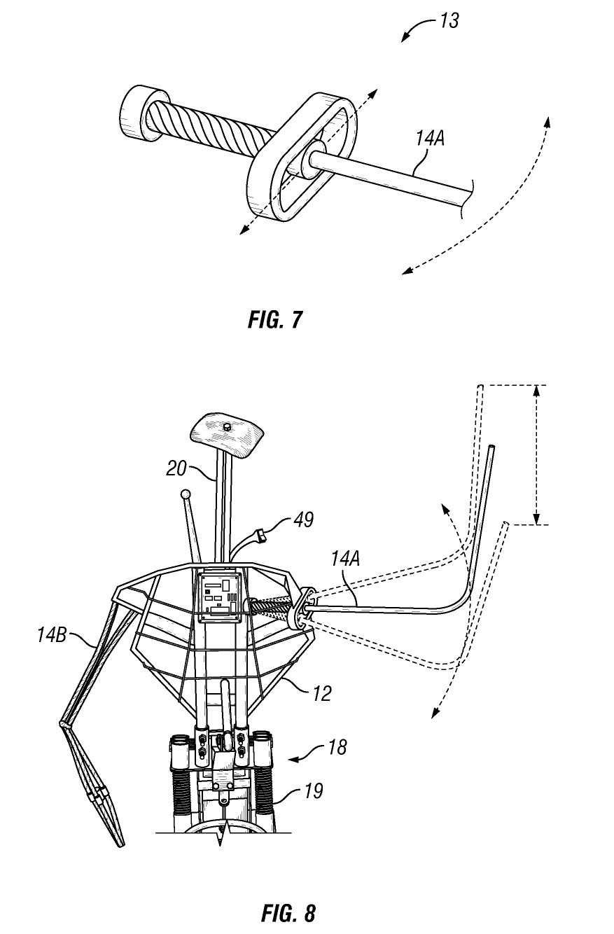

Suitable framework shoulder type attachments 13 for the upper extremities 14A, 14B include, but are not necessarily limited to hinged connections, flexible wire or cable that is connected to a solid torso 12 section, and ball joint couplings—each of which allows for unencumbered movement of the upper extremities 14A, 14B as desired. As depicted in FIG. 1, one suitable shoulder type attachment 13 may include a stop-plate 15 operationally configured to control the degree and range of motion of the upper extremity 14A. In another embodiment as depicted in FIG. 7, the shoulder type attachment 13 may include a ring type member operationally configured to control the degree and range of motion of the upper extremity 14A as indicated by the arrows. As stated previously, the upper extremities 14A, 14B are suitably constructed from materials including, but necessarily limited to metals, woods, plastic materials, composite materials, rubbers, and combinations thereof. In one suitable embodiment, the upper extremities 14A, 14B are constructed from one or more metals. In a particularly advantageous embodiment, the upper extremities 14A, 14B are constructed from aircraft grade stainless steel cable.

As desired, the second upper extremity 14B may be joined to the torso 12 in like manner as the first upper extremity 14A. In another embodiment, the upper extremity 14B may be joined to the torso 12 in a manner effective to minimize the movement of the second upper extremity 14B. In still another embodiment, the rider simulation apparatus 10 may exclude a second upper extremity 14B altogether.

It should be noted that the use of two upper extremities 14A, 14B may be implemented for aesthetic purposes—to most resemble a human rider. For example, a bull rider ideally keeps one hand attached to a rope with the arm close to the body during a ride, i.e., “the riding hand,” whereas the opposite arm may move freely about unencumbered, i.e., “the free hand”—as these phrases are known in the sport of bull riding. Thus, the rider simulation apparatus 10 may be oriented in like manner so that the second upper extremity 14B simulates the position of the riding hand. As stated, the attachment means of the second upper extremity 14B to the torso 12 may vary, but a suitable means of attachment of the riding hand is one operationally configured to limit the movement of the upper extremity 14B forward and backward in relation to the torso 12. In one particular embodiment, the shoulder type attachment 13 for the second upper extremity 14B, may include a hinged, spring loaded plate type member allowing for limited movement of both the shoulder joint and the upper extremity 14B forward and backward in relation to the torso 12. It is also contemplated that the framework not include a second upper extremity 14B, but rather the outer protective layer 30 include an appendage to simulate the riding hand minus any second upper extremity 14B therein.

As mentioned previously, the securing means 100 may also be operationally configured to simulate a human rider as desired. In other words, a securing means 100 designed for rough stock use is operationally configured to interact directly with the subject animal in like manner as the legs of a human rider. In the embodiment of FIG. 1, the securing means 100 includes lower extremities 16A, 16B that are biased toward one another forming a releasably secure fit on either side of a subject animal by compressing against the animal during operation. Although not limited to a particular length, during operation the lower extremities 16A, 16B suitably extend from a point on about the top center of an animal's back to at least halfway down either side of the subject animal. In one embodiment, the lower extremities 16A, 16B may include individual members separately attached to the resilient means 18. As shown in FIG. 1, the lower extremities 16A, 16B may include a one piece U-shaped member attached to the resilient means 18. In this embodiment, suitable lower extremities 16A, 16B are constructed from flexible materials such as spring steel and the like.

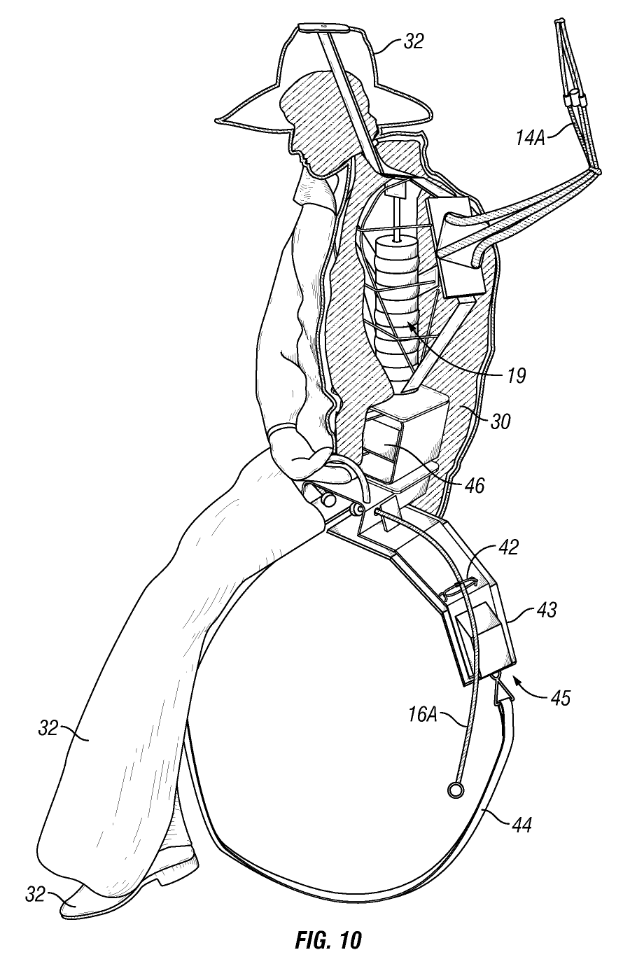

The securing means 100 of FIG. 2 may also include one or more lower extremities 16A and 16B as desired. In this embodiment, the lower extremities 16A, 16B are suitably operationally configured to spur the animal during operation. In one suitable embodiment, the lower extremities 16A, 16B may include a one piece member releasably or permanently attached to either the base 43 or the resilient means 18 as desired. In another embodiment, the one or more lower extremities 16A, 16B may include individual members releasably or permanently attached to either the base 43 or the resilient means 18 as desired. Herein, permanent type means of attachment include, but are not necessarily limited to knob type fasteners (see FIGS. 2 and 10), welds, adhesives, and combinations thereof. Suitable releasable type means of attachment include, but are not necessarily limited to threaded fasteners, rivot type fasteners, ball joint couplings, cam and groove couplings, and combinations thereof.

In an embodiment wherein the lower extremities 16A and 16B are attached to the resilient means 18, the lower extremities 16A and 16B are suitably operationally configured to move up to 360 degrees about the resilient means 18 during operation—depending on both the point of attachment to the resilient means 18 and the materials of construction of the extremities. As shown in FIG. 2, the lower extremities 16A and 16B may further be releasably secured to the base 43 via one or more fasteners 42 in a manner effective to allow the distal ends of the lower extremities 16A, 16B to move unencumbered apart from the base 43 during operation. Suitable fasteners 42 include, but are not necessarily limited to straps, loops, laces, clips, and combinations thereof. In still another embodiment, the lower extremities 16A and 16B may be partially housed within the base 43 as desired.

With further reference to FIG. 2, the securing means 100 suitably includes a latching means 45 operationally configured to releasably secure an end of the strap 44 to the base 43—thereby securing the rider simulation apparatus 10 to the subject animal. In an embodiment incorporating two straps 44, each strap 44 may include a latching means 45 for releasably securing each strap 44 to opposite ends of the base 43, whereby the free ends of each strap 44 are operationally configured to be fastened to one another directly or via one or more intermediate straps 44 or other connectors.

Suitably, the base 43 comprises a seat or saddle type member operationally configured to rest upon the back of an animal. In one embodiment, the base 43 includes a single member. In another embodiment, the base 43 includes a plurality of smaller sections secured together during operation. Although not limited to particular materials of construction, a suitable base 43 is constructed from metal, leather, plastic, heavy duty fabric, wood, and combinations thereof. In one particularly advantageous embodiment, the base 43 is constructed from metal including a soft pad like material disposed along the underside of the base 43 to provide comfort to the animal. Suitable metals include steel and aluminum. In another particularly advantageous embodiment, the base 43 is constructed from plastic including a similar padding material on the underside of the base 43. Pad like materials may include one or more fabrics, foam rubber, sponge materials, and other materials operationally configured to grab onto the animal to resist slipping of the base 43. The base 43 is suitably attached to the resilient means 18 via one or more means including, but not necessarily limited to welds, adhesive means, ties, threaded fasteners including screws, tape, tongue and groove type configurations, and combinations thereof.

As depicted in FIG. 2, the lower extremities 16A, 16B may suitably include flexible cable type members operationally configured so that at least a portion of the extremities may move unencumbered in response to the action of the subject animal. In particular, the lower extremities 16A, 16B may be partially fixed to the base 43 whereby a portion of the distal end of each extremity 16A, 16B may move separate and apart from the base 43. In this embodiment, the fixed portion of the extremities 16A, 16B remain substantially fixed against the subject animal allowing only the free portion of the extremities 16A, 16B to move unencumbered in reaction to the animal during operation. As such, the configuration of the securing means 100 in FIG. 2 is effective for producing a human like spurring action. It should be noted that rough stock animals often do not attempt to buck off known bucking dummies 40 sensing that the bucking dummy 40 is an inanimate object. Thus, a novel feature of the above described securing means 100 includes the ability to trick the subject animal into believing that something alive, rather than something inanimate, is on its back—increasing the animal's propensity to buck.

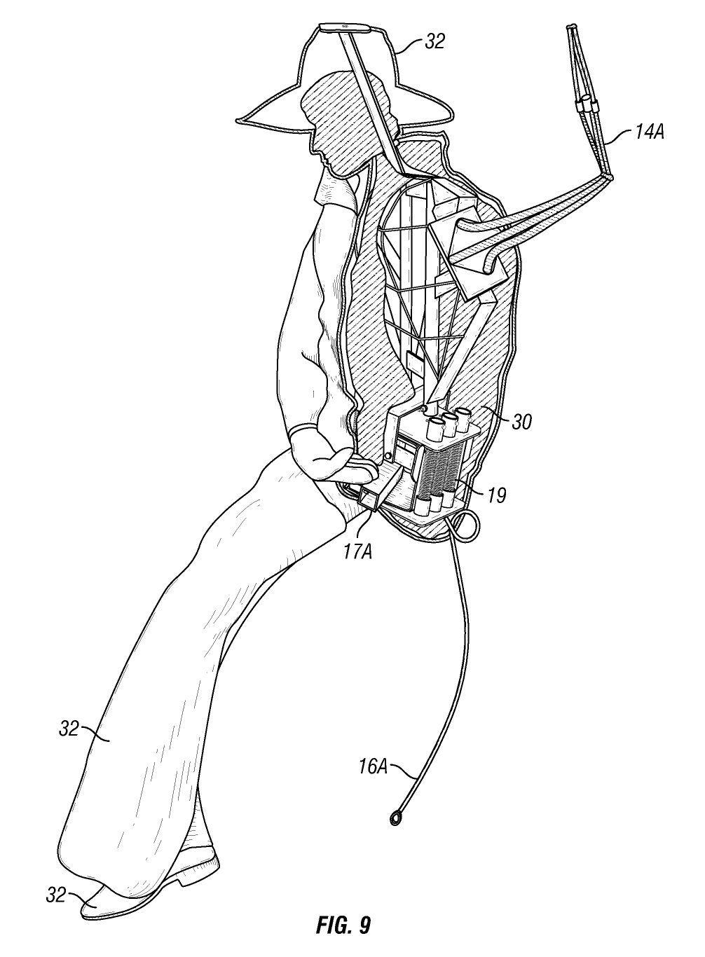

Turning now to FIGS. 9 and 10, the rider simulation apparatus 10 may include one or more external layers effective to cover or envelop all or a portion of the framework. Suitably, a framework comprised of the torso 12, extremities, and resilient means 18 serves as an endoskeleton enveloped by an outer protective layer 30. Although the outer protective layer 30 may take many forms, in a particularly advantageous embodiment, the outer protective layer 30 comprises a substantially human-like anatomically-correct, surface geometry. Without limiting the invention, the outer protective layer 30 suitably comprises one or more soft and/or lightweight and/or resilient impact shock absorbing materials that serve to prevent injury to the animal and to prevent damage to the rider simulation apparatus 10. A suitable outer protective layer 30 is constructed from one or more materials including, but not necessarily limited to those materials resistant to tearing, chipping, cracking, decomposing, degrading, and reshaping as a result of ozone, weathering, heat, moisture, other outside mechanical and chemical influences, as well as physical impacts encountered during operation of the rider simulation apparatus 10. Likewise, the outer protective layer 30 may also comprise any color or combination of colors. Depending on a particular use, or a particular size and/or weight of a desired rider simulation apparatus 10, the outer protective layer 30 may be constructed from materials including, but not necessarily limited to plastics, rubbers, sponge, and combinations thereof. Suitable plastics include, but are not necessarily limited to poly (vinyl chloride), polystyrene, polyethylene (polyethene), polypropylene (polypropene), polyamides (nylons), polyesters, acrylics, silicones, polyurethanes, and combinations thereof. Suitable rubbers include, but are not necessarily limited to synthetic rubber, natural rubber, modified natural rubber, and combinations thereof. Suitable synthetic rubbers include, but are not necessarily limited to nitrile rubber, silicone rubber, and combinations thereof. Suitable sponge materials include, for example, porous carbon, porous glass, paper, cardboard, cloth, and combinations thereof. In one particularly advantageous embodiment, the outer protective layer 30 is constructed from one or more foam materials. In another particularly advantageous embodiment, the outer protective layer 30 is constructed from high resiliency flexible polyethylene foam. In another particularly advantageous embodiment, the outer protective layer 30 is constructed from high resiliency flexible polyurethane foam.

As further illustrated in FIGS. 9-12, the rider simulation apparatus 10 may further include clothing 32 covering various parts of the outer protective layer 30 as desired. Suitable clothing 32 materials include clothing and shoe or boot items readily available in retail stores. In a like manner, wigs and hats may be place on a head type member of the rider simulation apparatus 10 as shown. In the embodiments of FIGS. 1 and 2, a pair of boots may be releasably attached to the lower extremities 16A, 16B, wherein the boots are operationally configured to spur the subject animal.

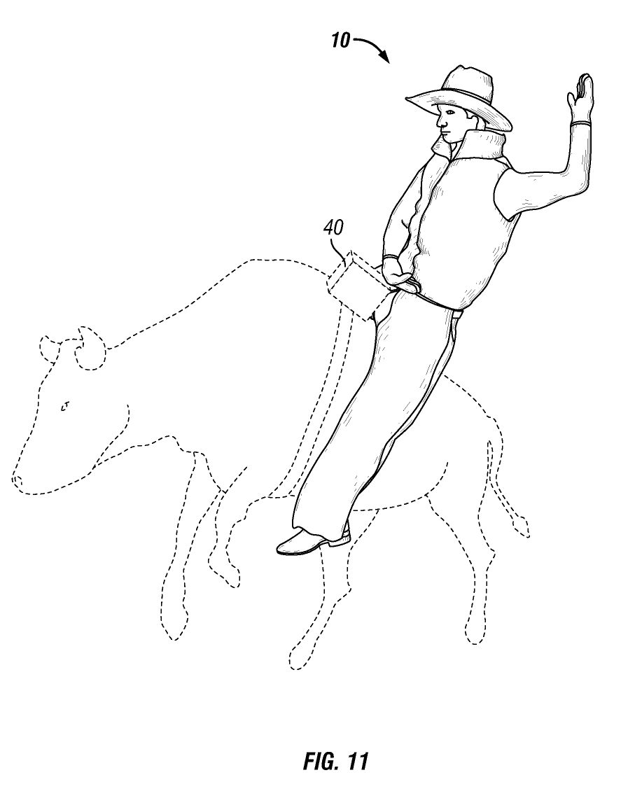

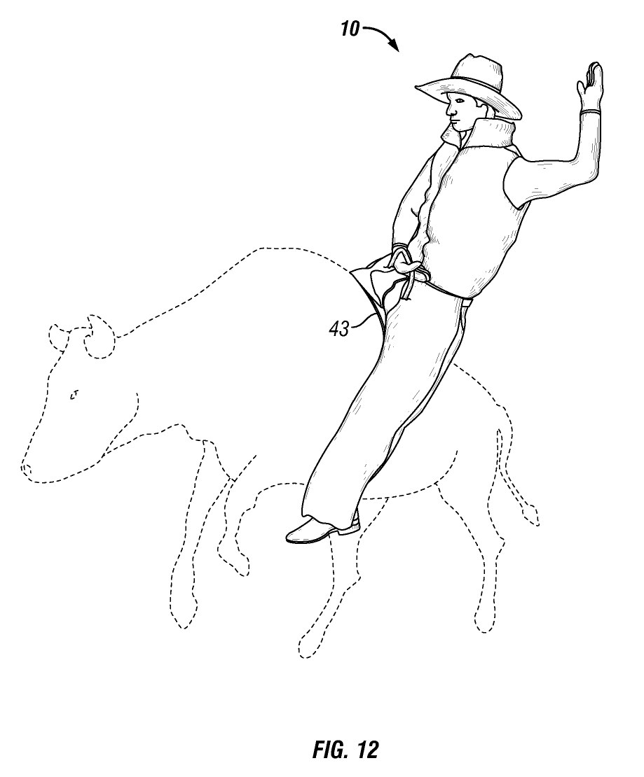

As depicted in FIG. 11, the rider simulation apparatus 10 may be attached to a bucking dummy 40 during operation on the back of an animal—the bucking dummy 40 suitably being operationally configured to release from the animal at a predetermined time as set by the user operator. Known bucking dummies are available from the following commercial sources: Central Texas Products Inc., Blanket, Tex.; MTK, Broken Arrow, Okla.; Buck 'Em All Dummies, Clyde, Tex., and Ro Bo Rider, Winona, Tex. It is also contemplated that the present rider simulation apparatus 10 may be used in conjunction with inanimate objects such as mechanical rodeo bulls. For instance, a mechanical rodeo bull may be used during the manufacturing process for quality control purposes to test a rider simulation apparatus 10 prior to sale.

The present invention will now be further characterized and described by reference to the following non-limiting examples, which are intended to be purely exemplary of the invention, and are not to be understood as limiting the invention in any way.

### Example 1

In one non-limiting method of operation, a developing bull is temporarily restrained in a pen or chute while the rider simulation apparatus 10 of FIG. 2 is placed on the back of the bull and secured at the approximate location as a human rider. The bull is then released from the chute and observed for a predetermined period of time as the bull attempts to buck or otherwise remove the rider simulation apparatus 10 from its back. After a period of observation, a user operator activates a hand held remote control sending an electromagnetic signal to a receiver within the rider simulation apparatus 10 operationally configured to unlock the latching means 45, thereby releasing the rider simulation apparatus 10 from the back of the bull. The rider simulation apparatus 10 falls off the bull to the ground and is afterward retrieved by the operator.

The period of observation or the elapsed time until signaling the release of the rider simulation apparatus 10 may change as desired. With young bulls, signaling the release of the apparatus early (from about one to about three seconds) during a particular ride is a developmental tool meant to serve as a positive reinforcement to the bull to exhibit a particular bucking action in order to remove the rider simulation apparatus 10 from its back. In other words, release of the rider simulation apparatus 10 at a predetermined time for a particular bull acts as a reward in training a bull to exhibit a particularly violent bucking action for a predetermined amount of time as means for “throwing” the rider simulation apparatus 10 as the term is understood by those of ordinary skill in the art of bull riding. Over time, a bull is encouraged to perform more aggressively for longer periods of time (from about five to about twelve seconds) in an attempt to throw the rider simulation apparatus 10—the intent being to provide better bulls for rodeo type events where typically a bull rider attempts to ride a bull for a period of eight seconds.

### Example 2

In another non-limiting method of operation, a developing bull is temporarily restrained in a pen or chute while a bucking dummy 40 is placed on the back of the bull. Once secured, the rider simulation apparatus 10 of FIG. 1 is releasably secured to the bucking dummy 40 via mating member 17A. The bull is then released from the chute and observed for a period of time as the bull attempts to buck or otherwise remove the rider simulation apparatus 10 from its back. After a period of observation, a user operator activates a hand held remote control sending an electromagnetic signal to a receiver within the bucking dummy 40, which releases the bucking dummy 40, and thus, the rider simulation apparatus 10 from the back of the bull. The bucking dummy 40 and the rider simulation apparatus 10 fall off the bull to the ground and are afterward retrieved by the user operator. The period of observation or the elapsed time until signaling the release of the rider simulation apparatus 10 may be altered similarly as described in Example 1.

### Example 3

In another non-limiting example, the rider simulation apparatus 10 of FIG. 1 comprises at least the following approximate dimensions and other features with regard to the endoskeleton framework:

| | |
|---|---|
| Total Height of Apparatus: | from about 66.0 inches to about 68.0 inches |
| | from about 167 cm to about 173 cm |
| Total Weight of Apparatus: | from about 56 lbs to about 90 lbs |
| | from 25.4 kg to about 40.8 kg |
| Torso Height: | from about 22.0 inches to about 26.0 inches |
| | from about 55.8 cm to about 66.0 cm |
| Torso Width: | from about 16.0 inches to about 20.0 inches |
| | from about 40.6 cm to about 50.8 cm |
| Torso Material: | Spring Carbon Steel |
| Neck Length: | from about 9.0 inches to about 11.0 inches |
| | from about 22.9 cm to about 27.9 cm |
| Neck Thickness: | from about 0.5 inches to about 2.0 inches |
| | from about 1.27 cm to about 5.1 cm |
| Midsection Member | from about 10.0 inches to about 15.0 inches |
| Height: | from about 25.4 cm to about 38.1 cm |
| Midsection Member Width: | from about 10.0 inches to about 14.0 inches |
| | from about 25.4 cm to about 35.6 cm |
| Midsection Member | Spring Carbon Steel |
| Material: | |
| Total Number of Coil | from about 4 to about 8 |
| Springs of Midsection | |
| Member: | |
| Coil Spring Height: | from about 5.0 inches to about 7.0 inches |
| | from about 12.7 cm to about 17.8 cm |
| Coil Spring Material: | Spring Carbon Steel |
| Total Length of One Piece | from about 25.0 inches to about 29.0 inches |
| Lower Extremity: | from about 63.5 cm to about 73.7 cm |
| Lower Extremity Material: | Spring Carbon Steel |
| Width between Distal Ends | from about 16.0 inches to about 20.0 inches |
| of Lower Extremity: | from about 40.6 cm to about 50.8 cm |

### Example 4

In another non-limiting example, the rider simulation apparatus 10 having the dimensions of the endoskeleton of Example 3 further includes the following features:
(1) Outer Protective Layer Material 30:
   A Combination of High Resiliency Flexible Polyurethane Foam, Foam Rubber, and Industrial Grade Adhesive Tape
(2) Dimensions of the Outer Surface of the Outer Protective Layer:

| | |
|---|---|
| Neck (length around): | from about 11.0 inches to about 13.0 inches |
| | from about 30.0 cm to about 33.0 cm |
| Torso (around): | from about 44.0 inches to about 50.0 inches |
| | from about 111.8 cm to about 127.0 cm |
| Upper Extremities (around): | from about 10.0 inches to about 15.0 inches |
| | from about 25.4 cm to about 38.1 cm |
| Midsection Member | from about 34.0 inches to about 40.0 inches |
| (around): | from about 86.4 cm to about 101.6 cm |
| Lower Extremities | from about 18.0 inches to about 24.0 inches |
| (around): | from about 45.7 cm to about 61.0 cm |

(3) Mannequin Head Attached to the Neck
(4) Clothing Materials: Cowboy Shirt on Torso, Blue Jeans on Lower Extremities, Cowboy Boots on Distal Ends of Lower Extremities, Wig and Cowboy Hat on the Mannequin Head.

Persons of ordinary skill in the art will recognize that many modifications may be made to the present application without departing from the spirit and scope of the application. The embodiment(s) described herein are meant to be illustrative only and should not be taken as limiting the invention, which is defined in the claims.

I claim:

1. A rider simulation apparatus comprising:
a torso;
a securing means for releasably mounting the apparatus to an animal; and
a resilient means for connecting the torso to the securing means in a neutral first position.

2. The rider simulation apparatus of claim 1, wherein the resilient means is operationally configured to move in a manner effective to direct the torso from a non-neutral second position to the neutral first position.

3. The rider simulation apparatus of claim 1, wherein the resilient means is operationally configured to center the torso during operation of the apparatus.

4. The rider simulation apparatus of claim 1, wherein the resilient means includes a dampener operationally configured to smooth out shock impulse and dissipate kinetic energy during operation of the apparatus.

5. The rider simulation apparatus of claim 1, further comprising one or more upper extremities attached to the torso.

6. The rider simulation apparatus of claim 5, wherein at least one upper extremity is joined to the torso in a manner effective to produce one or more human like shoulder type articulations during operation of the apparatus.

7. The rider simulation apparatus of claim 6, wherein the shoulder type articulations are selected from the group consisting of flexion, extension, adduction, abduction, transverse adduction, transverse flexion, transverse abduction, transverse extension, and combinations thereof.

8. The rider simulation apparatus of claim 5, wherein the one or more upper extremities are constructed from materials selected from the group consisting of metals, woods, plastic materials, composite materials, rubbers, and combinations thereof.

9. The rider simulation apparatus of claim 1, wherein the securing means comprises a girdle type configuration effective to releasably secure the apparatus to an animal.

10. The rider simulation apparatus of claim 1, wherein the securing means includes one or more lower extremities.

11. The rider simulation apparatus of claim 9, wherein the securing means includes one or more lower extremities.

12. The rider simulation apparatus of claim 10, wherein the one or more lower extremities are operationally configured to produce a spurring action during operation of the apparatus.

13. The rider simulation apparatus of claim 11, wherein the one or more lower extremities are operationally configured to produce a spurring action during operation of the apparatus.

14. The rider simulation apparatus of claim 10, wherein the one or more lower extremities are biased toward one another.

15. The rider simulation apparatus of claim 1, further comprising an outer protective layer enveloping the torso, securing means, and resilient means.

16. The rider simulation apparatus of claim 15, wherein the outer protective layer includes substantially human-like anatomically-correct, surface geometry.

17. The rider simulation apparatus of claim 15, wherein the outer protective layer is constructed from one or more foam materials.

18. The rider simulation apparatus of claim 15, wherein the outer protective layer is constructed from high resiliency flexible polyurethane foam.

19. The rider simulation apparatus of claim 15, further comprising clothing covering the outer protective layer.

20. The rider simulation apparatus of claim 1, wherein the apparatus is operationally configured to releasably secure to a bucking dummy.

21. The rider simulation apparatus of claim 1, further comprising circuitry including a timer switch operationally configured to automatically release the apparatus from the animal at a predetermined time following mounting of the apparatus to the animal.

22. The rider simulation apparatus of claim 1, wherein the torso is constructed from materials selected from the group consisting of metals, woods, plastic materials, composite materials, rubbers, and combinations thereof.

23. The rider simulation apparatus of claim 5, wherein the torso further comprises at least one shoulder type attachment operationally configured to control the degree and range of motion of a corresponding upper extremity.

24. The rider simulation apparatus of claim 1, wherein the resilient means is operationally configured to establish a resting neutral position of the torso in a forward position relevant to the resilient means.

25. A rider simulation apparatus releasably mountable to a rough stock animal comprising a substantially human-like skeletal framework including a torso, lower extremities, and a resilient means for connecting the lower extremities to the torso, the resilient means being operationally configured to center the torso during operation of the apparatus.

26. The rider simulation apparatus of claim 25, further comprising an outer protective layer enveloping the skeletal framework.

27. A method for developing a rough stock animal, comprising:
providing a rider simulation apparatus comprising a torso, a securing means for releasably mounting the apparatus to an animal, and a resilient means for connecting the torso to the securing means;
releasably mounting the rider simulation apparatus to a subject animal;
observing the animal for a predetermined period of time; and
activating the release of the apparatus from the animal following said period of time.

28. The method of claim 27 including a remote control means for activating release of the apparatus.

29. The method of claim 27 further comprising adding a human scent to the apparatus prior to observing the animal.

30. A system for developing a rough stock animal, comprising:
a bucking dummy releasably securable to a subject animal;
a remote control in wireless communication with the bucking dummy; and
a rider simulation apparatus comprising a torso, a securing means for releasably mounting the apparatus to an animal, and a resilient means for connecting the torso to the securing means, the rider simulation apparatus being releasably securable to the bucking dummy.
